(19) United States
(12) Patent Application Publication
(10) Pub. No.: US 2006/0095172 A1
(43) Pub. Date: May 4, 2006

(54) Optical navigation system for vehicles

(76) Inventors: Daniel Y. Abramovitch, Palo Alto, CA (US); Marshall T. Depue, San Jose, CA (US); Tong Xie, San Jose, CA (US)

Correspondence Address: AVAGO TECHNOLOGIES, LTD., P.O. BOX 1920, DENVER, CO, 80201-1920, US

(21) Appl. No.: 10/975,172

(22) Filed: Oct. 28, 2004

(51) Int. Cl. G08G 1/017; G01C 22/00

(52) U.S. Cl. 701/28; 340/937

(57) ABSTRACT

An optical vehicle motion detection system and a method for detecting motion of a vehicle. The optical vehicle motion detection system has at least one optical detector on a vehicle for detecting an image of a road surface and for generating image data corresponding to the detected image. An image processor processes image data of successive images of the road surface detected by the at least one optical detector as the vehicle travels along the road for determining positional change of the vehicle relative to the road surface and for generating vehicle motion data. The optical vehicle motion detection system can be incorporated in a vehicle navigation system to permit monitoring of the movement of the vehicle for accident prevention, traffic control and for other purposes.

### DESCRIPTION OF RELATED ART

Vehicle navigation systems have long been touted as a mechanism for reducing accidents, controlling traffic flow, guiding drivers to desired destinations, and for generally enhancing the overall driving experience.

All vehicle navigation systems require some form of sensing mechanism to detect vehicle movement. For example, it has been suggested to embed sensors in roads to track the motion of vehicles traveling along the roads. Such an approach, however, will necessitate tearing up existing roads to embed the sensors, require frequent maintenance, and be generally very expensive. It has also been suggested to mount antennas at regular intervals along the sides of roads to monitor vehicle movement. Such an approach will require establishing a large network of antennas throughout the country, and also be quite costly.

In general, although various technologies exist to monitor vehicle movement for a vehicle navigation system, none have proven to be practical or reasonably affordable.

### SUMMARY OF THE INVENTION

In accordance with the invention, an optical vehicle motion detection system is provided in which motion of a vehicle is determined by detecting positional change of the vehicle relative to a surface of a road along which the vehicle is traveling. An optical vehicle motion detection system according to the invention has at least one optical detector on a vehicle for detecting an image of a road surface and for generating image data corresponding to the detected image. An image processor processes image data corresponding to successive images of the road surface detected by the at least one optical detector as the vehicle travels along the road for determining positional change of the vehicle relative to the road surface and generates vehicle motion data. The optical vehicle motion detection system according to the invention can be incorporated in a vehicle navigation system to permit monitoring of the movement of the vehicle for accident prevention, traffic control and for other purposes.

### BRIEF DESCRIPTION OF THE DRAWINGS

Furthermore, the invention provides embodiments and other features and advantages in addition to or in lieu of those discussed above. Many of these features and advantages are apparent from the description below with reference to the following drawings.

FIG. 1 is a diagram that schematically illustrates an optical vehicle motion detection system according to an exemplary embodiment of the invention;

FIGS. 2A and 2B are diagrams that schematically illustrate a mechanism by which an optical vehicle motion detection system detects positional change of a vehicle according to a further exemplary embodiment of the invention;

FIG. 3 is a diagram that schematically illustrates an optical detector for an optical vehicle motion detection system according to a further exemplary embodiment of the invention;

FIG. 4 is a schematic side view of a vehicle having an optical vehicle motion detection system mounted thereon according to a further exemplary embodiment of the invention;

FIG. 5 is a diagram that schematically illustrates an optical detector for an optical vehicle motion detection system according to a further exemplary embodiment of the invention;

FIG. 6 is a schematic view of the underside of the vehicle illustrated in FIG. 4;

FIG. 7 is a block diagram that illustrates an optical navigation system incorporating optical vehicle motion detection systems on a plurality of vehicles according to a further exemplary embodiment of the invention; and

FIG. 8 is a flowchart that illustrates a method for detecting motion of a vehicle according to a further exemplary embodiment of the invention.

### DETAILED DESCRIPTION OF THE EXEMPLARY EMBODIMENTS OF THE INVENTION

Embodiments in accordance with the invention provide an optical vehicle motion detection system and a method for detecting motion of a vehicle.

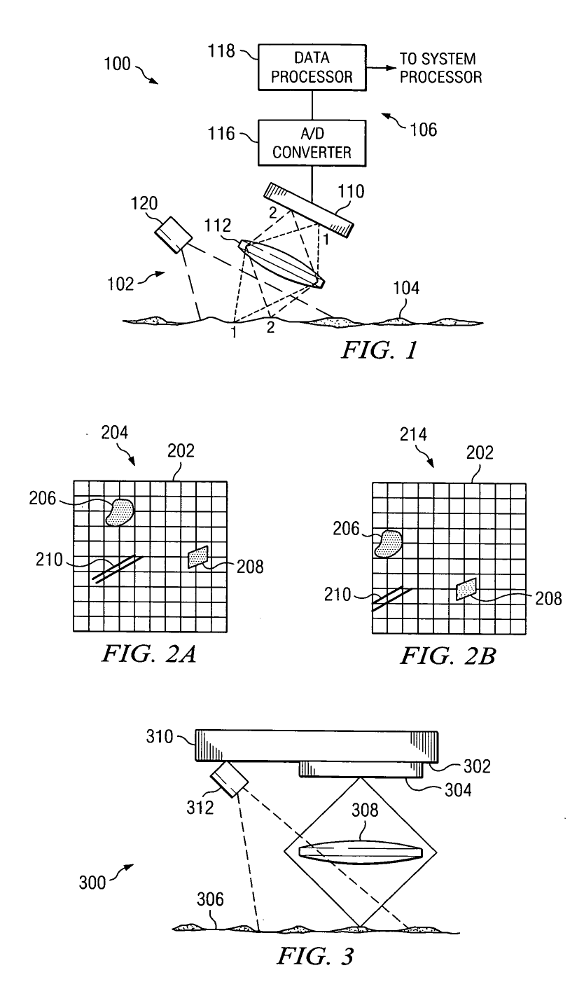

FIG. 1 is a diagram that schematically illustrates an optical vehicle motion detection system according to an exemplary embodiment in accordance with the invention. The optical vehicle motion detection system is generally designated by reference number 100 and is provided on a vehicle, not shown in FIG. 1, for example, by being mounted on the vehicle. Optical vehicle motion detection system 100 includes optical detector 102 for detecting images of road surface 104 and for generating image data corresponding to the detected images, and a motion detection circuit 106 for generating vehicle motion data from the image data.

In the exemplary embodiment illustrated in FIG. 1, optical detector 102 is a digital camera, however, it should be understood that the invention is not limited to any particular optical detector. Optical detector 102 includes photodetector 110 and lens system 112 for forming images of road surface 104 on photodetector 110. Motion detection circuit 106 includes analog/digital (A/D) converter 116 for converting analog image signals from photodetector 110 to digital image data, and data processor 118 for processing the digital image data from A/D converter 116. Data processor 118 processes and compares successive images of road surface 104 detected by optical detector 102 as the vehicle travels along the road for determining positional change of the vehicle relative to the road surface and for generating vehicle motion data therefrom.

As also shown in FIG. 1, light source 120 may be included in optical vehicle motion detection system 100 for illuminating the patch of road surface being detected by optical detector 102. Light source 120 can provide continuous illumination or an intermittent flash illumination.

As will be explained more fully hereinafter, optical vehicle motion detection system 100 is incorporated in a vehicle navigation system that includes a vehicle navigation system processor that receives the vehicle motion data generated by data processor 118 and generates data identifying the actual position of the vehicle. The actual position data is used by the vehicle navigation system to monitor movement of the vehicle.

Optical vehicle motion detection system 100 may be similar to an optical detection system used in an optical computer mouse to control the position of a cursor on a display screen of the computer. In particular, optical vehicle motion detection system 100 detects positional change of the vehicle by imaging the texture of a road surface similar to the manner in which an optical motion detection system of an optical mouse detects positional change of the mouse by imaging the texture of a mouse pad or the surface of a desk or the like.

FIGS. 2A and 2B are diagrams that schematically illustrate a mechanism by which an optical vehicle motion detection system detects positional change of a vehicle according to a further exemplary embodiment in accordance with the invention. FIG. 2A schematically illustrates a first image 204 of a patch of road surface imaged on a pixel array of photodetector 202 at a time t₁. As shown in FIG. 2A, the image may include one or more road features that impart a “texture” to the road surface. Such road features may include features on the road surface, such as pebble 206 or paint mark 208, or features in the road surface such as scratch 210. Each of these road features is imaged on photodetector 202 as shown in FIG. 2A (FIG. 1 also schematically illustrates two road features 1 and 2 being imaged on photodetector 110).

A second image 214 of the road surface is then formed on photodetector 202 at time t₂ after time t₁ as shown in FIG. 2B. As is apparent from a comparison of FIGS. 2A and 2B, although the same road features 206, 208 and 210 are imaged on photodetector 202 in image 214, the road features have moved downwardly and to the left indicating that the vehicle has moved upwardly and to the right between the successive images. Motion detection circuit 106 can generate data indicative of the motion of the vehicle between time t₁ and t₂ by correlating the positional change of road features 206, 208 and 210 between the two images. By taking many images, for example, thousands of images, of the road surface as the vehicle travels down a road, and correlating successive images, an accurate determination of vehicle motion can be provided.

It should be recognized that some road features detected by the optical detector may move somewhat as a result of the vehicle traveling over them. Such movable features may include, for example, cigarette butts, twigs, small pebbles and the like. Generally, it is believed that such features will tend to remain relatively stationary until picked up by turbulent air at the trailing edge of the vehicle after being detected by the optical detector; and thus will not significantly affect the accuracy of the vehicle motion determination. Also, inasmuch as vehicle motion is typically determined by averaging over thousands of images, the effects of such movable features will normally not be significant in any event.

An optical vehicle motion detection system according to exemplary embodiments in accordance with the invention should detect images of a road surface at frequent intervals, for example, about every 1-10 centimeters of travel, in order to permit vehicle motion to be accurately determined. At a maximum vehicle speed of 100 miles per hour, a sample rate of 4,469 kHz will result in an image being detected for every centimeter of vehicle travel. At more typical vehicle speeds, a reduced sample rate may be used and at slow vehicle speeds, for example, when parking a vehicle, the sample rate may be reduced even further. In general, the sample rate may be maintained at a constant value irrespective of vehicle speed, or may be adjusted as a function of the speed of the vehicle.

FIG. 3 is a diagram that schematically illustrates an optical detector for an optical vehicle motion detection system according to a further exemplary embodiment in accordance with the invention. Optical detector 102 in the exemplary embodiment illustrated in FIG. 1 is shown as being angled relative to the road surface being imaged. The optical detector can also be oriented normal to the road surface as shown in FIG. 3. In particular, FIG. 3 illustrates optical detector 300 having photodetector 302 mounted to the underside of vehicle 310 such that imaging surface 304 of photodetector 302 is substantially parallel to road surface 306. Lens system 308 forms images of road surface 306 on surface 304 of photodetector 302. Light source 312 illuminates the patch of road surface 306 being detected by optical detector 300.

Although, as indicated above, optical vehicle motion detection system 100 may be similar to an optical detection system used in an optical computer mouse, an optical vehicle motion detection system presents many problems that are not encountered in the operation of an optical mouse. For example, in an optical vehicle motion detection system, it is important that the optical detector maintain visual contact with a road surface at all times in order to be able to accurately determine positional change of a vehicle relative to the road surface. The nature and condition of a road surface, however, can vary significantly and significant variations in the road surface can affect the ability of the optical detector to maintain visual contact with the road surface. For example, roads are constructed of concrete, asphalt, gravel and other materials, and the surface of a particular road may vary from place to place as a result of changes in the material of which the road is constructed. Also, even on a road constructed of a single material, the condition of the road surface can vary from place to place as a result of a new surface being applied to different portions of a road. As a vehicle transitions from one type of road surface to another, abrupt changes in the texture of the road surface may cause the optical detector to lose visual contact with the road surface.

Similarly, the condition of the road surface can vary as a result of dirt, snow, rain and the like which can also make it difficult for the optical detector to maintain proper visual contact with the road surface.

According to a further exemplary embodiment in accordance with the invention, loss of visual contact with a road surface by an optical detector can be obviated by providing an optical vehicle motion detection system that includes a plurality of optical detectors mounted at different locations on the vehicle.

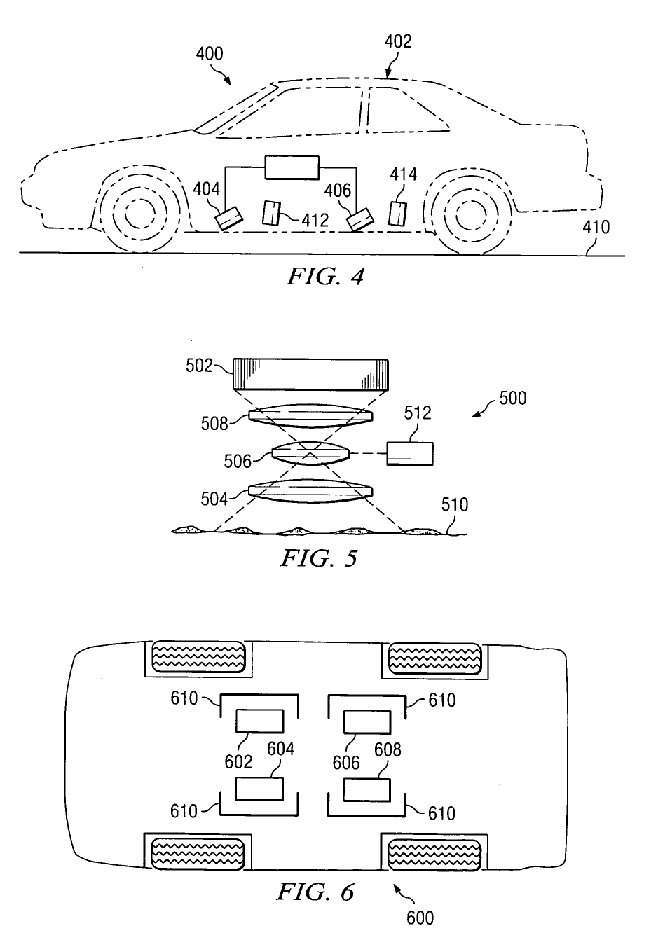

FIG. 4 is a schematic side view of a vehicle having an optical vehicle motion detection system mounted thereon according to a further exemplary embodiment in accordance with the invention. The optical vehicle motion detecting system is generally designated by reference number 400 and includes a plurality of optical detectors mounted at different locations on the underside of the chassis of vehicle 402 to detect images of road surface 410 as vehicle 402 travels along the road (although only two optical detectors 404 and 406 are illustrated in FIG. 4, it should be understood that optical vehicle motion detection system 400 can include any desired number of optical detectors without departing from the invention). As also illustrated in FIG. 4, light sources 412 and 414 may be included in optical vehicle motion detection system 400 for illuminating patches of road surface detected by optical detectors 404 and 406, respectively.

By mounting a plurality of optical detectors at different locations on a vehicle, even if one optical detector loses visual contact with the road surface, it is likely that another of the plurality of optical detectors will maintain visual contact with the road surface and enable optical vehicle motion detection system 400 to continue to track positional change of the vehicle relative to the road surface.

As shown in FIG. 4, optical detector 404 is mounted on vehicle 402 toward the front end of the vehicle, and optical detector 406 is mounted on vehicle 402 toward the rear end of the vehicle. By positioning optical detectors 404 and 406 in such a manner, if vehicle 402 abruptly transitions from one type of road surface to another, optical detector 404 positioned toward the front end of the vehicle will encounter the transition before optical detector 406 positioned towards the rear end of the vehicle. Accordingly, even if optical detector 404 loses visual contact with road surface 410 as a result of the transition, optical detector 406 positioned toward the rear end of the vehicle will still be over the old road surface and be able to detect images of the road surface while optical detector 404 calibrates itself to the new road surface.

As a vehicle travels along a road, the vehicle chassis will tend to move up and down, changing the height of optical detectors mounted thereon relative to the road surface. Because the height changes are normally relatively slow as compared to the speed of the optical detectors, the optical detectors can usually track the height changes without losing visual contact with the road surface. A sudden and significant change in the height of an optical detector relative to the road surface, however, as a result of hitting a large bump, for example, may cause the optical detector to tilt and lose visual contact with the road surface. By providing a plurality of optical detector at different locations on the vehicle, however, it is probable that at least one of the plurality of optical detectors will maintain visual contact with the road surface permitting positional change of the vehicle to be tracked while optical detectors that lose visual contact with the road surface reacquire their position.

In general, when considering the effect of optical detectors losing visual contact with a road surface, general concepts relating to an observer that tracks the state of a system in the presence of disturbances and imprecise measurements are useful. A Kalman filter is a special case of a discrete time observer where gains are chosen to minimize the effects of mean square noise in the system and at a detector. In effect, the optical vehicle motion detection system of the present invention detects abrupt changes in the road surface and ignores measurements from optical detectors that require recalibration while accepting measurements from optical detectors that are properly tracking the road.

Variations in the height of an optical detector as a result of up and down movement of the vehicle as it travels along a road can also be accommodated by a lens system with a large depth of field or a lens system with variable focus.

FIG. 5 is a diagram that schematically illustrates an optical detector for an optical vehicle motion detection system according to a further exemplary embodiment in accordance with the invention. The optical detector is generally designated by reference number 500 and comprises photodetector 502 and a variable focus lens system comprised of a plurality of lenses 504, 506 and 508 for forming images of road surface 510 on photodetector 502. Optical detector 500 also includes an autofocus capability, schematically illustrated at 512, to control the variable focus lens system for maintaining optical detector 500 in proper visual contact with road surface 510. By providing an autofocus capability that is sufficiently fast to compensate for height variations of the vehicle as the vehicle travels along a road, the images formed on photodetector 502 will remain clear and sharp.

In an optical vehicle motion detection system according to embodiments in accordance with the present invention, the optical detectors are spaced several inches above the surface of the road being imaged. As a result, the optical detectors are susceptible to receiving spurious light that can affect the ability of the detectors to properly track the road surface. This can particularly be a problem during daylight hours. The effects of spurious light can be reduced somewhat by positioning the plurality of optical detectors toward the center of the vehicle and away from the edges of the vehicle.

FIG. 6 is a schematic view of the underside of vehicle 400 illustrated in FIG. 4, and designated as vehicle 600 in FIG. 6. As shown in FIG. 6, a plurality of optical detectors 602, 604, 606 and 608 are positioned at spaced locations on the underside of vehicle 600 toward the center of the vehicle and away from edges of the vehicle to reduce the amount of spurious light reaching the optical detectors. The effects of spurious light can also be further reduced by providing shields around the optical detectors as shown at 610 and/or by illuminating the road surface with a form of illumination that is not present to any significant extent in daylight.

There is also some concern that the plurality of optical detectors can become dirty from road grime and the like. This problem can be obviated by recessing the optical detectors within a support tube, for example, by a couple of centimeters, and/or by providing a cowling or other protective structure to help divert dirt away from the optical detectors. If desired, a mechanism can also be provided to actively clean the optical detectors. For example, a dirt detector can be provided to monitor each optical detector and to activate a small sprayer or wiper when an optical detector becomes dirty. The dirt detectors can each include a projection system to project a known pattern, for example, a bar pattern, onto the road surface to be imaged by the optical detector. The detected image is compared with a stored version of the correct pattern to determine if the optical detector is dirty.

The optical vehicle motion detection system according to exemplary embodiments in accordance with the present invention can take many forms. For example, optical detectors of the system can include photodetectors comprising low resolution CCDs (charge coupled devices) or CMOS (complementary metal oxide semiconductor) image sensors. The light sources can be LEDs (light emitting diodes) or other suitable light sources. The light sources can provide a constant illumination or an intermittent illumination via a flash capability. The light sources can emit visible light or non-visible light, such as IR, and can also be selected to emit a preferred color, for example, by using a plurality of different LEDs, to improve the contrast or to reduce the effects of spurious light.

According to another exemplary embodiment in accordance with the invention, the optical detectors can each be a digital camera having a variable focus lens system with an autofocus capability as described above to assist in maintaining visual contact with the road surface as the vehicle travels along the road. A camera also provides an advantage of requiring very little light to illuminate the road surface, except, perhaps, at night. At night, an automatic flash feature can be provided to illuminate the road surface.

A camera provided with a variable focus lens system can also be provided to accommodate vehicles having different chassis heights. A simple image processing algorithm can be used to automatically adjust the focus to maximize image contrast. Alternatively, the focus can be fixed at the factory depending on the model of the vehicle on which the camera is to be mounted.

In general, optical detectors of an optical vehicle motion detection system according to exemplary embodiments in accordance with the invention must provide sufficient pixels to form sharp images of the road surface to permit positional change of the vehicle relative to the road surface to be accurately determined. The resolution must be sufficient to resolve relatively smooth road surfaces, for example, icy surfaces, but be small enough to process efficiently. In a camera, the relatively long focal length between the camera and the image increases the need for pixels, however, the need to image only a small patch of road surface decreases the pixel requirements. In general, for a patch of road surface 30 mm×30 mm, a resolution on the order of 1 mm² is satisfactory.

Both autofocus cameras and computer mouse-type optical detectors are quite inexpensive and can be installed and replaced as frequently as necessary. The optical vehicle motion detection system of the present invention can be provided as original equipment on new vehicles or as add-ons to existing vehicles.

The optical vehicle motion detection system according to exemplary embodiments in accordance with the invention determines positional change of a vehicle relative to a road surface, and, accordingly, provides information regarding the relative position of a vehicle. In a vehicle navigation system, however, some mechanism is needed to establish the absolute position of the vehicle. A system such as GPS (Global Positioning System) can, for example, be used to establish a starting position for a vehicle, and the absolute vehicle position at any time can be determined from the GPS measurement. Alternatively, fiducials can be positioned at infrequent locations on or along a road to enable the optical vehicle motion detection system of the present invention to periodically acquire the absolute position of the vehicle. The fiducials can, for example, be provided on lines on the road that are detected when the vehicle travels over the lines. Alternatively, the fiducials can be provided on utility poles along the side of the road or in another manner.

By being able to determine the absolute position of a vehicle at any time, the optical vehicle motion detection system according to embodiments in accordance with the invention can be incorporated in a vehicle navigation system to monitor the position of the vehicle. The vehicle navigation system can be used to direct a driver to a desired location or to monitor the driver's driving ability, e.g., to detect erratic driving due to intoxication or drowsiness. The system can also be incorporated into a network to provide a real-time assessment of road and weather conditions.

An optical vehicle motion detection system according to exemplary embodiments in accordance with the invention can also be used maintain a record of vehicle travel. For example, sensor, motion and position data indicative of vehicle travel can be recorded in a vehicle “black box” data recorder and stored for use in accident investigations and for other purposes.

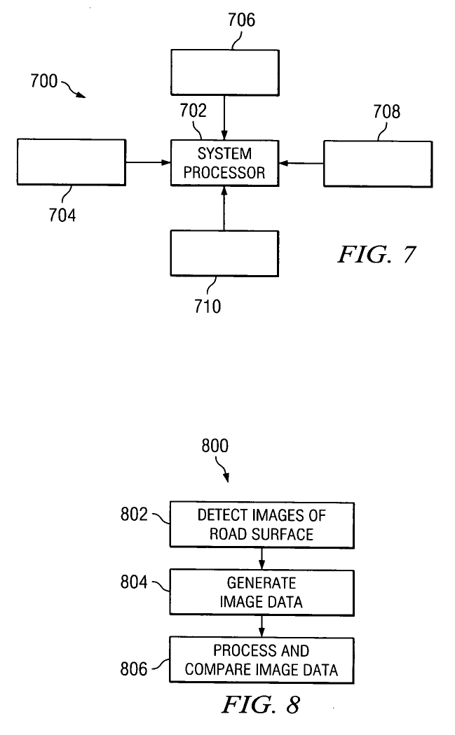

An optical vehicle motion detection system according to exemplary embodiments in accordance with the invention can be provided on different vehicles, and the optical navigation system can be used to improve traffic flow and reduce accidents by, for example, maintaining proper distances between vehicles. FIG. 7 is a block diagram that illustrates an optical navigation system incorporating optical vehicle motion detection systems on a plurality of vehicles according to a further exemplary embodiment in accordance with the invention. The optical navigation system is generally designated by reference number 700, and, as shown, includes a system processor 702 that receives vehicle motion data from a plurality of vehicles 704, 706, 708 and 710 and processes the motion data to control traffic flow and the like.

FIG. 8 is a flowchart that illustrates a method for detecting motion of a vehicle according to a further exemplary embodiment in accordance with the invention. The method is generally designated by reference number 800 and begins by detecting sequential images of a road surface as a vehicle is traveling along a road (step 802). Image data corresponding to the successive images is generated (step 804), and the generated image data is compared and processed for determining positional change of the vehicle relative to the road (step 806).

While what has been described constitute exemplary embodiments in accordance with the invention, it should be recognized that embodiments in accordance with the invention can be varied in numerous ways without departing from the scope thereof. Because embodiments in accordance with the invention can be varied in numerous ways, it should be understood that the invention should be limited only insofar as is required by the scope of the following claims.

1. An optical vehicle motion detection system, comprising:
at least one optical detector on a vehicle for detecting an image of a surface of a road and for generating image data corresponding to the detected image, the at least one optical detector including a variable focus lens system; and
an image processor for processing generated image data of successive images of the road surface detected by the at least one optical detector as the vehicle travels along the road for determining positional change of the vehicle relative to the road surface.

2. The system according to claim 1, wherein the at least one optical detector comprises a plurality of optical detectors at different locations on the vehicle.

3. The system according to claim 2, wherein the plurality of optical detectors are mounted at different locations on the underside of the vehicle.

4. The system according to claim 3, wherein the plurality of optical detectors includes at least one optical detector positioned toward a front end of the vehicle, and at least one optical detector positioned toward a rear end of the vehicle.

5. The system according to claim 3 wherein the plurality of optical detectors are positioned toward the center of the vehicle.

6. The system according to claim 1, and further including a light source associated with each at least one optical detector for illuminating a patch of road detected by the at least one optical detector.

7. The system according to claim 6, wherein the light source comprises one of a light source for providing continuous illumination and a light source for providing intermittent illumination.

8. The system according to claim 6, wherein the light source comprises one of a light source for emitting visible light and a light source for emitting non-visible light.

9. The system according to claim 6, wherein the light source comprises a light emitting diode light source.

10. The system according to claim 1, wherein the at least one optical detector comprises at least one of a CCD detector and a CMOS detector.

11. The system according to claim 1, wherein the at least one optical detector comprises at least one digital camera.

12. The system according to claim 11, wherein the at least one digital camera includes the variable focus lens system.

13. The system according to claim 11, wherein the at least one digital camera includes an autofocus capability.

14. The system according to claim 1, and further including a shielding member for shielding the at least one optical detector from spurious light.

15. The system according to claim 1, and further including a data storage for storing information regarding motion and position of the vehicle.

16. A method for detecting the motion of a vehicle, comprising:
detecting sequential images of a road surface as a vehicle is traveling along a road, including focusing the sequential images variably;
generating image data corresponding to the sequential images; and
processing and comparing the generated image data for determining positional change of the vehicle relative to the road surface.

17. The method according to claim 16, wherein the detecting comprises detecting sequential images of the road surface from a plurality of locations on the vehicle as the vehicle is traveling along the road.

18. The method according to claim 17, wherein the detecting comprises detecting sequential images of the road surface from a plurality of locations on the underside of the vehicle as the vehicle is traveling along the road.

19. The method according to claim 17, wherein the detecting comprises detecting sequential images of the road surface from at least one location toward a front end of the vehicle and from at least one location toward a rear end of the vehicle as the vehicle is traveling along the road.

20. The method according to claim 16, and further including generating vehicle motion data from the determined positional change.

21. The method according to claim 20, and further including:
providing reference position information for the vehicle; and
determining an absolute position of the vehicle from the reference position information and the vehicle motion data.

22. The method according to claim 21, wherein the reference position information comprises vehicle starting position information.

23. The method according to claim 16, and further including storing information regarding motion and position of the vehicle.

24. A vehicle navigation system, comprising:
a plurality of vehicles, each of the vehicles having an optical vehicle motion detection system including:
at least one optical detector on the vehicle for detecting an image of a surface of a road and for generating image data corresponding to the detected image; and
an image processor for processing generated image data of successive images of the road surface detected by the at least one optical detector as the vehicle travels along the road for determining positional change of the vehicle relative to the road and for generating vehicle motion data; and
a navigation system processor coupled to each of the vehicles for determining an absolute position of each vehicle from associated vehicle reference position information and the associated vehicle motion data.

25. The vehicle navigation system according to claim 24, wherein the vehicle reference position information comprises vehicle starting position information.

26. (canceled)

27. The vehicle navigation system according to claim 24, wherein the vehicle navigation system further includes a mechanism for periodically reacquiring vehicle reference position information.

28. The vehicle navigation system according to claim 24, wherein the navigation system processor is further for determining relative positional relationships among the plurality of vehicles based on the absolute positions.
